(19) United States
(12) Patent Application Publication
(10) Pub. No.: US 2026/0078994 A1
(43) Pub. Date: Mar. 19, 2026

(54) GAUGE FOR INSPECTING AN APERTURE OF A WORKPIECE AND A METHOD

(71) Applicant: The Boeing Company, Arlington, VA (US)

(72) Inventors: Kieran Jin Kai Tay, Goose Creek, SC (US); Andrew James Maass, Charleston, SC (US)

(73) Assignee: The Boeing Company, Arlington, VA (US)

(21) Appl. No.: 18/884,450

(22) Filed: Sep. 13, 2024

(51) Int. Cl. G01B 3/52

(52) U.S. Cl. CPC G01B 3/52

(57) ABSTRACT

A gauge for inspecting an aperture of a workpiece includes a body having a hole gauge portion configured to be disposed in a hole portion of the aperture and a countersink gauge portion configured to be disposed in a countersink portion of the aperture. The gauge includes a hinge connecting the hole gauge portion and the countersink gauge portion to allow the countersink gauge portion to move relative to the hole gauge portion. The gauge includes an indicator coupled to the body. The indicator is configured to indicate whether a predetermined tolerance is obtained between the countersink portion and the hole portion of the aperture. A method of determining a predetermined tolerance of an aperture of a workpiece uses the gauge.

### BACKGROUND

Various workpieces require holes to receive fasteners. Some of these holes may have countersinks. Separate manufacturing processes may be implemented to form holes and corresponding countersinks in separate operations. For example, one drilling process may be implemented to form the hole and a separate, second drilling process may be implemented to form the countersink. In this situation, the holes and the corresponding countersinks may have different centerlines.

### SUMMARY

Therefore, the present disclosure provides a gauge to inspect an aperture, which, for example, may indicate whether a hole centerline and a countersink centerline are within a predetermined tolerance.

The present disclosure provides a gauge for inspecting an aperture of a workpiece. The aperture includes a countersink portion and a hole portion adjoining each other. The gauge includes a body having a hole gauge portion configured to be disposed in the hole portion of the aperture and a countersink gauge portion configured to be disposed in the countersink portion of the aperture. The gauge also includes a hinge connecting the hole gauge portion and the countersink gauge portion to allow the countersink gauge portion to move relative to the hole gauge portion. The gauge further includes an indicator coupled to the body. The indicator is configured to indicate whether a predetermined tolerance is obtained between the countersink portion and the hole portion of the aperture.

The present disclosure provides a method of determining a predetermined tolerance of an aperture of a workpiece. A hole gauge portion of a gauge is inserted into a hole portion of the aperture of the workpiece until a countersink gauge portion of the gauge is seated to a countersink portion of the aperture. A hinge connects the hole gauge portion and the countersink gauge portion which allows the countersink gauge portion to move relative to the hole gauge portion once seated in the countersink portion. An indicator, coupled to the gauge, indicates whether the predetermined tolerance is obtained between the countersink portion and the hole portion of the aperture.

The detailed description and the drawings or figures are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic front-side view of a gauge seated in an aperture of a workpiece having an indicator of a first configuration in a go position.

FIG. 2 is a schematic back-side view of the gauge of FIG. 1.

FIG. 3 is a schematic perspective view of the gauge of FIGS. 1 and 2 relative to the back-side of the gauge.

FIG. 4 is a schematic cross-sectional view of the gauge of FIG. 1.

FIG. 5 is a schematic front-side view of the gauge seated in the aperture of the workpiece having an indicator of a second configuration in a go position.

FIG. 6 is a schematic front-side view of the gauge of FIG. 5 with the indicator in a no-go position.

FIG. 7 is a schematic back-side view of the gauge of FIG. 5.

FIG. 8 is a schematic cross-sectional view of the gauge of FIG. 5.

FIG. 9 is a schematic enlarged view of the indicator taken from circular-line 9 of FIG. 5.

FIG. 10 is a schematic illustration of a hole centerline of the aperture of the workpiece and a countersink centerline of the aperture of the workpiece.

FIG. 11 is a schematic fragmented view of the gauge identifying features to calculate a total width of a window of the gauge.

The present disclosure may be extended to modifications and alternative forms, with representative configurations shown by way of example in the drawings and described in detail below. Inventive aspects of the disclosure are not limited to the disclosed configurations. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims. Moreover, terms such as “first,” “second,” “third,” and so on, may be used to describe separate components. Such terminology may include the words specifically mentioned above, derivatives thereof, and words of similar import. Furthermore, the term “substantially” can refer to a slight imprecision or slight variance of a condition, quantity, value, or dimension, etc., some of which are within manufacturing variance or tolerance ranges.

As used herein, an element or step recited in the singular and preceded by the word “a” or “an” should be understood as not necessarily excluding the plural of the elements or steps. That is, “a”, “an”, “the”, “at least one”, and “one or more” are used interchangeably to indicate that at least one of the items is present and more than one may be present, unless stated otherwise. Further, any reference to “one configuration” is not intended to be interpreted as excluding the existence of additional configurations that also incorporate the recited features. Moreover, unless explicitly stated to the contrary, configurations “comprising” or “having” an element or a plurality of elements having a particular property may include additional elements not having that property. The phrase “at least one of” as used herein should be construed to include the non-exclusive logical “or”, i.e., A and/or B and so on depending on the number of components.

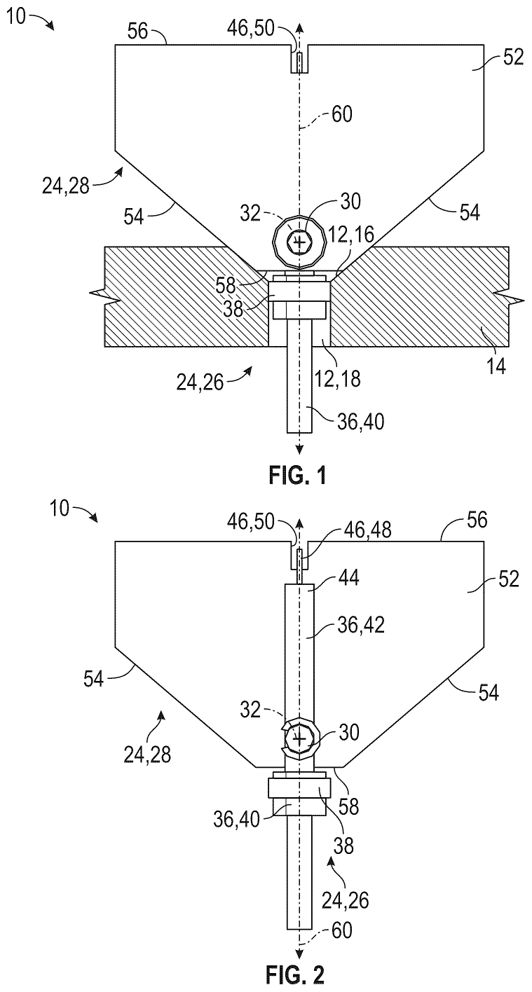

Referring to the figures, wherein like numerals indicate like or corresponding parts throughout the several views, a gauge 10 for inspecting an aperture 12 of a workpiece 14 is generally shown in FIG. 1. Once the aperture 12 is created, the gauge 10 is inserted into the aperture 12 of the workpiece 14, in which information about the aperture 12 is obtained via the gauge 10. That is, the gauge 10 may be implemented to determine whether a predetermined tolerance has been obtained for the aperture 12 of the workpiece 14, which will be discussed further below.

The gauge 10 may be used for any configuration of the workpiece 14 where it is desirable to inspect any of the apertures 12 of the workpiece 14, and some non-limiting examples of the workpiece 14 are discussed next. For example, the workpiece 14 may one or more parts of a flight vehicle, such as aircraft, drones, payloads, space shuttles, satellites, etc.; one or more parts of a movable platform, such as locomotives, automobiles, off-road vehicles, watercrafts, trailers, farm equipment, etc.; one or more parts of a non-movable platform such as equipment, buildings, farm equipment, or any other structure that may use the gauge 10 described herein. If the workpiece 14 is for the flight vehicle, such as the aircraft, non-limiting examples of the workpiece 14 may include one or more panels, skins, frames, brackets, spars, chords, engine cowl, stringers, bulkheads, doors, or any other structural members that may use the gauge 10 described herein.

Regardless of the configuration of the workpiece 14, the workpiece 14 may define one aperture 12 or a plurality of apertures 12, and the gauge 10 described herein may be used for any number of the apertures 12 of the workpiece 14. The apertures 12 of the workpiece 14 may be formed by any suitable process, such as drilled, cut, formed, etc. Regardless of how the apertures 12 are created, some of the apertures 12 may have both a hole and a countersink (see FIG. 1). Therefore, in certain configurations, the aperture 12 includes a countersink portion 16 and a hole portion 18 adjoining each other.

Optionally, two different or separate processes may be implemented to form the apertures 12. For example, one drilling process may be used to form the hole portion 18 and a separate drilling process may be used to form the countersink portion 16. Generally, the hole portion 18 of the aperture 12 is centered on a hole centerline 20 and the countersink portion 16 of the aperture 12 is centered on a countersink centerline 22 (see FIG. 10). In certain situations, due to the forming process, the hole and the countersink may have different centerlines 20, 22 (see FIG. 10). That is, the centerlines 20, 22 may not be concentric relative to each other. Generally, the gauge 10 described herein may indicate whether the hole centerline 20 of the aperture 12 and the countersink centerline 22 of the aperture 12 are within the predetermined tolerance. That is, the gauge 10 described herein may be implemented to determine whether the countersink portion 16 and the hole portion 18 of the aperture 12 are aligned along the respective centerlines 20, 22 within the predetermined tolerance. The predetermined tolerance referred to herein may be any suitable value based on one or more of engineering parameters, government parameters, design parameters, manufacturing parameters, specification parameters, etc.

As such, the gauge 10 may indicate, measure, determine, identify, etc., a difference in angularity Θ_{d} (see FIG. 10) between the hole centerline 20 and the countersink centerline 22. If the difference of angularity Θ_{d} is within the predetermined tolerance, then the aperture 12 meets the engineering parameters, government parameters, design parameters, manufacturing parameters, specification parameters, etc. If the difference of angularity Θ_{d} is not within the predetermined tolerance, then the aperture 12 does not meet one or more of the engineering parameters, government parameters, design parameters, manufacturing parameters, specification parameters, etc., and one or more additional processes may be required to the aperture 12 and/or the workpiece 14 may need to be reworked.

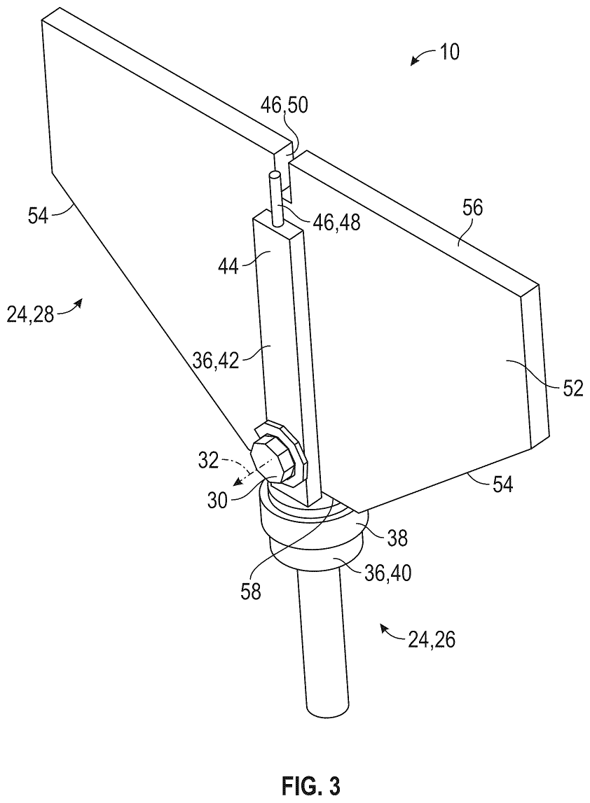

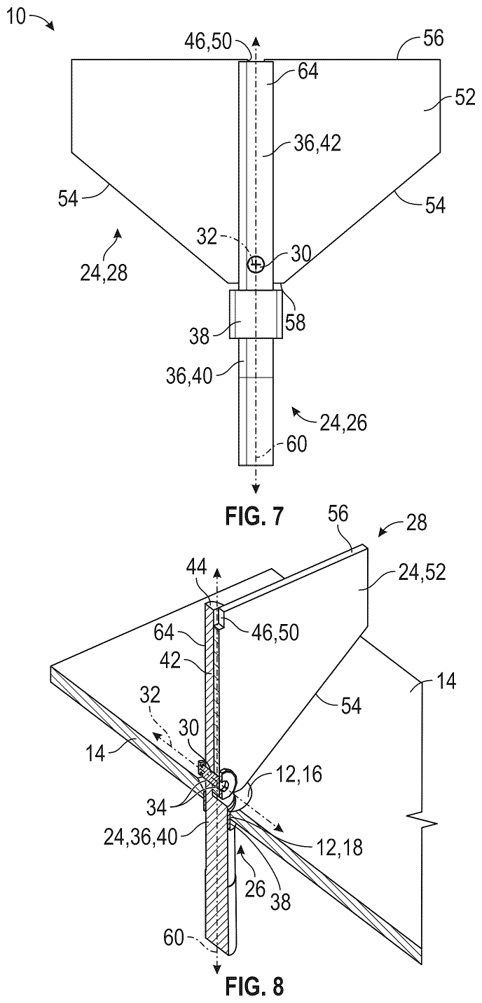

Referring to FIGS. 1-8, the gauge 10 includes a body 24 having a hole gauge portion 26 configured to be disposed in the hole portion 18 of the aperture 12 and a countersink gauge portion 28 configured to be disposed in the countersink portion 16 of the aperture 12. Generally, the hole gauge portion 26 aligns along the hole centerline 20, and the countersink gauge portion 28 aligns along the countersink centerline 22. The hole gauge portion 26 and the countersink gauge portion 28 of the gauge 10 cooperate to provide the difference of angularity Θ_{d} As such, the gauge 10 may be used to measure the difference of angularity Θ_{d} between the hole centerline 20 and the countersink centerline 22, and the information obtained from the difference of angularity Θ_{d} may be used to determine whether the respective centerlines 20, 22 are within the predetermined tolerance. A first position or a go position is obtained if the gauge 10 indicates that the centerlines 20, 22 are within the predetermined tolerance (see FIGS. 1, 2, 5, 9, and 11). A second position or a no-go position is obtained if the gauge 10 indicates that the centerlines 20, 22 are not within the predetermined tolerance (see FIG. 6).

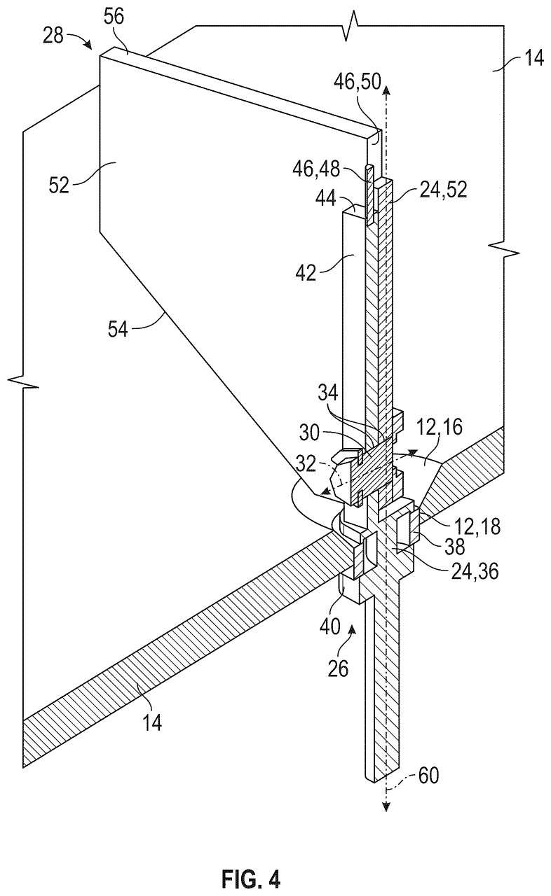

Referring to FIGS. 4 and 8, the gauge 10 also includes a hinge 30 connecting the hole gauge portion 26 and the countersink gauge portion 28 to allow the countersink gauge portion 28 to move relative to the hole gauge portion 26. For example, the hinge 30 allows movement of the countersink gauge portion 28 relative to the hole gauge portion 26 to fully seat the countersink gauge portion 28 into the countersink portion 16 even if the hole centerline 20 is different from the countersink centerline 22. For example, the countersink gauge portion 28 may rotate about a first axis 32 in a first direction and a second direction opposite to the first direction.

The hinge 30 may be any suitable configuration to allow the countersink gauge portion 28 to move relative to the hole gauge portion 26. In certain configurations, the hinge 30 is a pin extending along the first axis 32. Continuing with the pin example, the pin may extend through the hole gauge portion 26 and the countersink gauge portion 28. Therefore, the hole gauge portion 26 and the countersink gauge portion 28 each define an opening 34 that the pin extends through. Other non-limiting examples of the hinge 30 may include a fastener, a post, a press-fit shoulder pin, a grooved shoulder pin using a retaining ring, etc.

Generally, the hole gauge portion 26 remains stationary inside the hole portion 18 of the aperture 12 so that the hole gauge portion 26 aligns on the hole centerline 20. Referring to FIGS. 1, 4, 5, and 8, the hole gauge portion 26 may include a post 36 and an alignment feature 38 coupled to the post 36. Generally, the alignment feature 38 centers the hole gauge portion 26 along the hole centerline 20 when the post 36 is disposed inside of the hole portion 18.

In certain configurations, the post 36 may include a first post portion 40 and a second post portion 42 fixed to the first post portion 40. At least part of the first post portion 40 and the alignment feature 38 are disposed inside of the hole portion 18 such that the alignment feature 38 centers the post 36 inside of the hole portion 18 which centers the hole gauge portion 26 relative to the hole portion 18. The alignment feature 38 may be any suitable configuration, and non-limiting examples may include a seal, a plug, a spacer, a gasket, gaffers tape, or any other feature that maintains the post 36 centered inside of the hole portion 18.

Continuing with FIGS. 1, 4, 5, and 8, the first post portion 40 and the second post portion 42 may be formed as one piece such as integral to each other or may be separate pieces fixed to each other. For illustrative purposes, the figures illustrate the post 36 as one piece, i.e., the first post portion 40 and the second post portion 42 are integral with each other. Generally, the first post portion 40 and the second post portion 42 extend outwardly away from each other in opposite directions. The second post portion 42 extends outwardly away from the first post portion 40 to a distal end 44.

Optionally, the first post portion 40 may extend beyond the workpiece 14, i.e., beyond the hole portion 18, which provides a way for a user to grab/position the gauge 10 in the aperture 12. That is, the first post portion 40 may extend beyond the workpiece 14 in the opposite direction than the second post portion 42. FIGS. 1, 4, 5, 6, and 8 illustrate the first post portion 40 extending beyond the workpiece 14 to provide a way to grab/position the gauge 10 relative to the aperture 12.

As another option, the second post portion 42 may extend beyond the plate 52 which provides a way for a user to grab/position the gauge 10 in the aperture 12. That is, the second post portion 42 may extend beyond the plate 52 in the opposite direction than the first post portion 40.

Generally, the hinge 30 is disposed through the post 36 of the hole gauge portion 26. In certain configurations, the hinge 30 is disposed through the second post portion 42 and the countersink gauge portion 28. The hinge 30 allows the countersink gauge portion 28 to move relative to the post 36, and in certain configurations, allows movement relative to the second post portion 42.

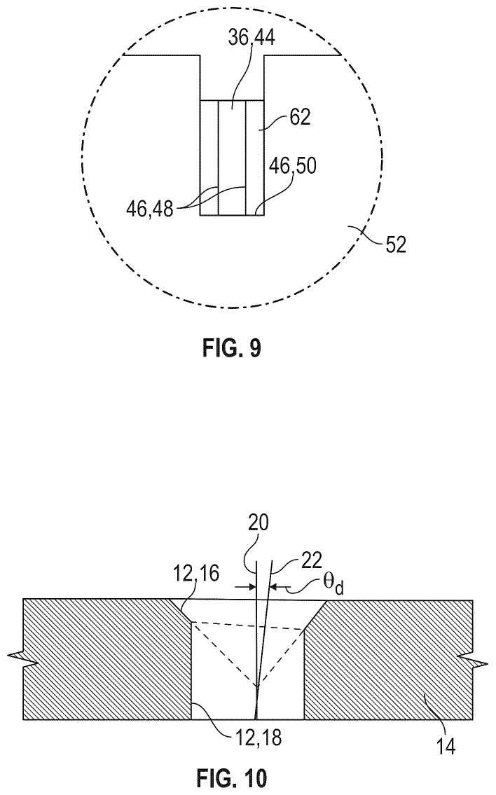

As best shown in FIGS. 1 and 9, the gauge 10 also includes an indicator 46 coupled to the body 24. The indicator 46 is configured to indicate whether the predetermined tolerance is obtained between the countersink portion 16 and the hole portion 18 of the aperture 12. In certain configurations, part of the indicator 46 is coupled to the hole portion 18 and part of the indicator 46 is coupled to the countersink portion 16. As such, one part of the indicator 46 is movable relative to another part of the indicator 46. Therefore, when the gauge 10 is disposed in the hole portion 18, the hole gauge portion 26 aligns along the hole centerline 20, and the countersink gauge portion 28 may move relative to the hole gauge portion 26 to allow the countersink gauge portion 28 to align along the countersink centerline 22. The indicator 46 indicates whether the difference in angularity Θ_{d} between the hole centerline 20 and the countersink centerline 22 is within the predetermined tolerance.

Referring to FIGS. 1-3, 5, 6, and 9, the indicator 46 may include a stationary portion 48 and a window 50. Therefore, the one part of the indicator 46 is the stationary portion 48 and the other part of the indicator 46 is the window 50. Generally, the stationary portion 48 is fixed to the hole gauge portion 26, and the countersink gauge portion 28 defines the window 50. In certain configurations, the stationary portion 48 may be fixed to the post 36 such that the stationary portion 48 extends beyond the post 36, and in certain configurations, the stationary portion 48 extends beyond the second post portion 42. The countersink gauge portion 28 is movable relative to the hole gauge portion 26 when seated in the countersink portion 16 of the aperture 12 such that the window 50 is movable relative to the stationary portion 48 to indicate whether the predetermined tolerance is obtained. As such, once the hole gauge portion 26 is disposed in the hole portion 18, the stationary portion 48 remains stationary while the window 50 moves relative to the stationary portion 48. Therefore, depending on the position of the stationary portion 48 relative to the window 50, this will indicate whether the centerlines 20, 22 are within the predetermined tolerance. For example, as shown in FIGS. 1, 2, 5, 9, and 11, the stationary portion 48 is visible within the window 50, which indicates that the first position or the go position is obtained, and thus, indicates that the centerlines 20, 22 are within the predetermined tolerance. As another example, as shown in FIG. 6, the stationary portion 48 is not visible within the window 50, which indicates that the second position or the no-go position is obtained, and thus, indicates that the centerlines 20, 22 are not within the predetermined tolerance.

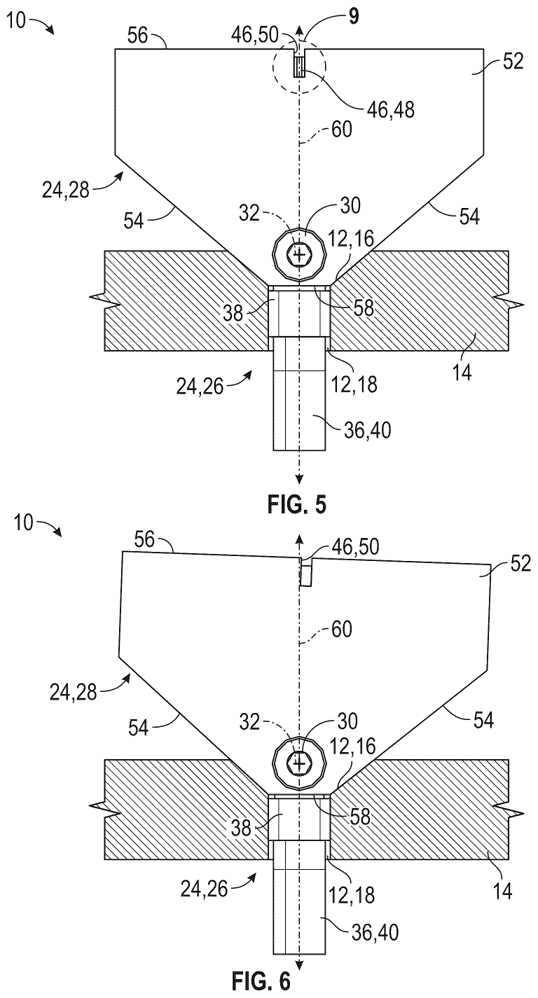

Referring to FIGS. 1-8, the countersink gauge portion 28 may include a plate 52 having a pair of tapered edges 54 opposing each other. More specifically, in certain configurations, the plate 52 has a top edge portion 56 defining the window 50 and a bottom edge portion 58 having the pair of tapered edges 54 opposing each other. Referring to FIGS. 1 and 5, the top edge portion 56 and the bottom edge portion 58 may be spaced from each other along a longitudinal axis 60. Generally, the longitudinal axis 60 and the first axis 32 are transverse to each other.

The tapered edges 54 angle or taper outwardly away from the longitudinal axis 60 from the bottom edge portion 58 toward the top edge portion 56. The tapered edges 54 are configured to complement the angle of the countersink portion 16 of aperture 12 such that the tapered edges 54 seat into the countersink portion 16 when the gauge 10 is disposed inside of the aperture 12. The tapered edges 54 engage the workpiece 14 inside of the countersink portion 16 of the aperture 12 (when the gauge 10 is seated in the aperture 12), and thus, the bottom edge portion 58 of the gauge 10 may be disposed inside of the countersink portion 16. By seating the countersink gauge portion 28 into the countersink portion 16, the tapered edges 54 seat against the countersink portion 16, which allows the countersink gauge portion 28 to center along the countersink centerline 22 of the countersink portion 16. When the gauge 10 is disposed inside of the aperture 12, the longitudinal axis 60 may be disposed axially inside of the aperture 12.

In certain configurations, the hinge 30 may be disposed proximal to the bottom edge portion 58 of the countersink portion 16. That is, the hinge 30 may be disposed closer to the bottom edge portion 58 than to the top edge portion 56 (see FIGS. 1-8). The hinge 30 may be disposed through the plate 52, with the plate 52 being rotatable about the hinge 30 relative to the post 36. When the hinge 30 is the pin, the pin may extend through the plate 52 such that the plate 52 is rotatable about the first axis 32.

The indicator 46 may be any suitable configuration, and non-limiting examples of the indicator 46 may include a needle (see FIGS. 1-4) or a marking (see FIGS. 5-9 and 11). The indicator 46 may be any suitable configuration to provide a visual indication relative to the window 50. Therefore, the marking or markings may include etchings, printing, indicia, graphics, symbols, text, etc. that provides a visual indicator. The needle may include a post, a finger, a stanchion, an upright, a beam, a bar, or any structure that extends from the post 36 to provide a visual indicator.

As mentioned above, the indicator 46 may include the window 50 and optionally the needle or the marking. In certain configurations, the window 50 is defined by the plate 52, and thus, the needle or the marking is coupled to the post 36. As such, part of the indicator 46 remains stationary relative to movement of the window 50, and thus, the needle or the marking remains stationary as the window 50 moves to seat into the countersink portion 16. In certain configurations, the needle is fixed to the distal end 44 of the second post portion 42, and the needle may extend beyond the distal end 44 of the post 36. When the indicator 46 includes the marking, the distal end 44 of the second post portion 42 may include the marking, and in certain configurations, the post 36 may include a first side 62 facing toward the countersink gauge portion 28 such as the plate 52 and a second side 64 opposing the first side 62 such that the second side 64 faces outwardly away from the countersink gauge portion 28. In certain configurations, the distal end 44 of the post 36 along the first side 62 may include the marking, which is visible in the window 50 when the countersink gauge portion 28 is in the go position (see FIG. 9).

Depending on the location of the stationary portion 48 relative to the window 50, this position will indicate whether the countersink portion 16 and the hole portion 18 are within the predetermined tolerance. The stationary portion 48, such as the needle or the marking, is visible inside of the window 50 to indicate that the predetermined tolerance is obtained, i.e., the go position (see FIGS. 1, 2, 5, 9, and 11). The stationary portion 48, such as the needle or the marking, is not visible inside of the window 50 to indicate that the predetermined tolerance is not obtained, i.e., the no-go position (see FIG. 6).

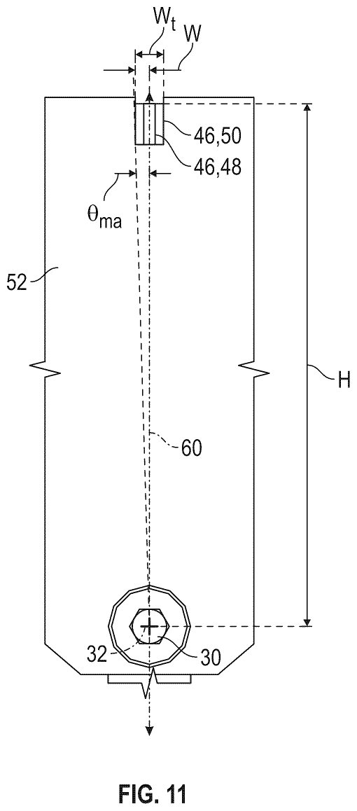

The size of the window 50 may be determined depending on one or more of engineering parameters, government parameters, design parameters, manufacturing parameters, specification parameters, etc. That is, certain apertures 12 of the workpiece 14 may require a predetermined tolerance that requires a certain sized window 50, and then certain other apertures 12 of the workpiece 14 may require a different predetermined tolerance that requires a different sized window 50. As such, referring to FIG. 11, a total width Wₜ of the window 50 is determined by the desired predetermined tolerance of the aperture 12. Therefore, each of the gauges 10 may be tailored to the desired predetermined tolerance of the respective apertures 12. To obtain a total width Wₜ of the window 50 for any of the gauges 10, two equations may be used. First, one-side of a width W of the window 50 is calculated via equation (1):

$$W = H \times tan ( {θ}_{ma} ) \qquad ( 1 )$$

wherein:
W is a width of one-side of the window 50 relative to the longitudinal axis 60;
H is a height from the first axis 32 to the top of the stationary portion 48 substantially parallel to the longitudinal axis 60; and
Θₘₐ is a predetermined maximum angle of the difference in angularity Θ_{d} relative to one-side of the longitudinal axis 60.

The width W obtained from equation (1) is then used to calculate the total width Wₜ of the window 50 via equation (2):

$${W}_{t} = W \times 2 \qquad ( 2 )$$

wherein:
W is the width of one-side of the window 50 relative to the longitudinal axis 60; and
Wₜ is the total width of the window 50.

The present disclosure also provides a method of determining the predetermined tolerance of the aperture 12 of the workpiece 14.

Generally, the method includes inserting the gauge 10 into the aperture 12 of the workpiece 14. More specifically, the hole gauge portion 26 of the gauge 10 is inserted into the hole portion 18 of the aperture 12 of the workpiece 14 until the countersink gauge portion 28 of the gauge 10 is seated to the countersink portion 16 of the aperture 12. That is, the hole gauge portion 26 is inserted into the hole portion 18 of the aperture 12 which causes the hole gauge portion 26 to align along the hole centerline 20 of the hole portion 18 of the aperture 12, and the countersink gauge portion 28 seats into the countersink portion 16 of the aperture 12 which causes the countersink gauge portion 28 to align along the countersink centerline 22 of the countersink portion 16 of the aperture 12.

As discussed above, the hinge 30 connects the hole gauge portion 26 and the countersink gauge portion 28 which allows the countersink gauge portion 28 to move relative to the hole gauge portion 26 once seated in the countersink portion 16.

The method includes indicating, via the indicator 46 coupled to the gauge 10, whether the predetermined tolerance is obtained between the countersink portion 16 and the hole portion 18 of the aperture 12. The indicator 46 indicates whether the difference in angularity Θ_{d} between the hole centerline 20 and the countersink centerline 22 is within the predetermined tolerance. The indicator 46 indicates that the predetermined tolerance is obtained when the stationary portion 48 of the indicator 46 is visible inside of the window 50 of the indicator 46 (see FIGS. 1, 2, 5, 9, and 11). The indicator 46 indicates that the predetermined tolerance is not obtained when the stationary portion 48 is not visible inside of the window 50 of the indicator 46 (see FIG. 6).

It is to be appreciated that the order or sequence of performing the method as described herein is for illustrative purposes and other orders or sequences are within the scope of the present teachings. It is to also be appreciated that the method may include other features not specifically discussed immediately above.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration can be combined with one or a plurality of other desired characteristics from other configurations, resulting in other configurations not described in words or by reference to the drawings. Accordingly, such other configurations fall within the framework of the scope of the appended claims.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The illustrations of the configurations described herein are intended to provide a general understanding of the structure of the various configurations. The illustrations are not intended to serve as a complete description of all of the elements and features of apparatus and systems that utilize the structures or methods described herein. Many other configurations may be apparent to those of skill in the art upon reviewing the disclosure. Other configurations may be utilized and derived from the disclosure, such that structural and logical substitutions and changes may be made without departing from the scope of the disclosure. Accordingly, the disclosure and the figures are to be regarded as illustrative rather than restrictive.

The following Clauses provide some example configurations of the gauge 10 and the method as disclosed herein.
Clause 1: A gauge for inspecting an aperture of a workpiece, wherein the aperture includes a countersink portion and a hole portion adjoining each other, the gauge comprising: a body having a hole gauge portion configured to be disposed in the hole portion of the aperture and a countersink gauge portion configured to be disposed in the countersink portion of the aperture; a hinge connecting the hole gauge portion and the countersink gauge portion to allow the countersink gauge portion to move relative to the hole gauge portion; and an indicator coupled to the body and configured to indicate whether a predetermined tolerance is obtained between the countersink portion and the hole portion of the aperture.
Clause 2: The gauge as set forth in clause 1 wherein the hole portion of the aperture is centered on a hole centerline, and wherein the hole gauge portion aligns along the hole centerline.
Clause 3: The gauge as set forth in clauses 1 or 2 wherein the countersink portion of the aperture is centered on a countersink centerline, and wherein the countersink gauge portion aligns along the countersink centerline.
Clause 4: The gauge as set forth in any one of clauses 1-3 wherein the indicator indicates whether a difference in angularity between the hole centerline and the countersink centerline is within the predetermined tolerance.
Clause 5: The gauge as set forth in any one of the preceding clauses wherein the indicator includes a stationary portion and a window.
Clause 6: The gauge as set forth in clause 5 wherein the stationary portion is fixed to the hole gauge portion, and the countersink gauge portion defines the window.
Clause 7: The gauge as set forth in clauses 5 or 6 wherein the countersink gauge portion is movable relative to the hole gauge portion when seated in the countersink portion of the aperture such that the window is movable relative to the stationary portion to indicate whether the predetermined tolerance is obtained.
Clause 8: The gauge as set forth in any one of clauses 5-7 wherein the stationary portion is visible inside of the window to indicate that the predetermined tolerance is obtained.
Clause 9: The gauge as set forth in any one of clauses 5-8 wherein the stationary portion is not visible inside of the window to indicate that the predetermined tolerance is not obtained.
Clause 10: The gauge as set forth in any one of the preceding clauses wherein the hole gauge portion includes a post and an alignment feature coupled to the post, wherein the post includes a first post portion, and at least part of the first post portion and the alignment feature are disposed inside of the hole portion such that the alignment feature centers the post inside of the hole portion which centers the hole gauge portion relative to the hole portion.
Clause 11: The gauge as set forth in clause 10 wherein the post includes a second post portion fixed to the first post portion, and the second post portion extends outwardly away from the first post portion to a distal end, wherein the hinge is disposed through the second post portion and the countersink gauge portion.
Clause 12: The gauge as set forth in clauses 10 or 11 wherein: the indicator includes a window and a needle fixed to the distal end of the second post portion; the countersink gauge portion includes a plate having a top edge portion defining the window and a bottom edge portion having a pair of tapered edges opposing each other; and the tapered edges engage the workpiece inside of the countersink portion of the aperture.
Clause 13: The gauge as set forth in clause 12 wherein the hinge is disposed proximal to the bottom edge portion of the countersink portion.
Clause 14: The gauge as set forth in clauses 12 or 13 wherein: the hinge is a pin extending along a first axis; and the pin extends through the plate such that the plate is rotatable about the first axis.
Clause 15: The gauge as set forth in any one of the preceding clauses wherein: the indicator includes a stationary portion and a window; the hole portion of the aperture is centered on a hole centerline, wherein the hole gauge portion aligns along the hole centerline; the hole gauge portion includes a post and an alignment feature coupled to the post such that the alignment feature centers the hole gauge portion along the hole centerline when the post is disposed inside of the hole portion; the countersink portion of the aperture is centered on a countersink centerline, wherein the countersink gauge portion aligns along the countersink centerline; the indicator indicates whether a difference in angularity between the hole centerline and the countersink centerline is within the predetermined tolerance; the stationary portion is fixed to the post such that the stationary portion extends beyond the post; and the countersink gauge portion includes a plate having a top edge portion defining the window and a bottom edge portion having a pair of tapered edges opposing each other.
Clause 16: The gauge as set forth in any one of the preceding clauses wherein: the hole gauge portion includes a post and an alignment feature coupled to the post; the countersink gauge portion includes a plate having a pair of tapered edges opposing each other; and the indicator includes a stationary portion extending from the post and a window defined by the plate.
Clause 17: The gauge as set forth in any one of the preceding clauses wherein the indicator includes a needle or a marking.
Clause 18: A method of determining a predetermined tolerance of an aperture of a workpiece, the method comprising: inserting a hole gauge portion of a gauge into a hole portion of the aperture of the workpiece until a countersink gauge portion of the gauge is seated to a countersink portion of the aperture, wherein a hinge connects the hole gauge portion and the countersink gauge portion which allows the countersink gauge portion to move relative to the hole gauge portion once seated in the countersink portion; and indicating, via an indicator coupled to the gauge, whether the predetermined tolerance is obtained between the countersink portion and the hole portion of the aperture.
Clause 19: The method as set forth in clause 18 wherein: inserting the hole gauge portion into the hole portion of the aperture causes the hole gauge portion to align along a hole centerline of the hole portion of the aperture; seating the countersink gauge portion into the countersink portion of the aperture causes the countersink gauge portion to align along a countersink centerline of the countersink portion of the aperture; and indicating, via the indicator, whether a difference in angularity between the hole centerline and the countersink centerline is within the predetermined tolerance.
Clause 20: The method as set forth in clauses 18 or 19 wherein: indicating, via the indicator, further comprises indicating that the predetermined tolerance is obtained when a stationary portion of the indicator is visible inside of a window of the indicator; and indicating, via the indicator, further comprises indicating that the predetermined tolerance is not obtained when the stationary portion is not visible inside of the window of the indicator.

What is claimed is:

1. A gauge for inspecting an aperture of a workpiece, wherein the aperture includes a countersink portion and a hole portion adjoining each other, the gauge comprising:
a body having a hole gauge portion configured to be disposed in the hole portion of the aperture and a countersink gauge portion configured to be disposed in the countersink portion of the aperture;
a hinge connecting the hole gauge portion and the countersink gauge portion to allow the countersink gauge portion to move relative to the hole gauge portion; and
an indicator coupled to the body and configured to indicate whether a predetermined tolerance is obtained between the countersink portion and the hole portion of the aperture.

2. The gauge as set forth in claim 1 wherein the hole portion of the aperture is centered on a hole centerline, and wherein the hole gauge portion aligns along the hole centerline.

3. The gauge as set forth in claim 2 wherein the countersink portion of the aperture is centered on a countersink centerline, and wherein the countersink gauge portion aligns along the countersink centerline.

4. The gauge as set forth in claim 3 wherein the indicator indicates whether a difference in angularity between the hole centerline and the countersink centerline is within the predetermined tolerance.

5. The gauge as set forth in claim 1 wherein the indicator includes a stationary portion and a window.

6. The gauge as set forth in claim 5 wherein the stationary portion is fixed to the hole gauge portion, and the countersink gauge portion defines the window.

7. The gauge as set forth in claim 6 wherein the countersink gauge portion is movable relative to the hole gauge portion when seated in the countersink portion of the aperture such that the window is movable relative to the stationary portion to indicate whether the predetermined tolerance is obtained.

8. The gauge as set forth in claim 7 wherein the stationary portion is visible inside of the window to indicate that the predetermined tolerance is obtained.

9. The gauge as set forth in claim 8 wherein the stationary portion is not visible inside of the window to indicate that the predetermined tolerance is not obtained.

10. The gauge as set forth in claim 1 wherein the hole gauge portion includes a post and an alignment feature coupled to the post, wherein the post includes a first post portion, and at least part of the first post portion and the alignment feature are disposed inside of the hole portion such that the alignment feature centers the post inside of the hole portion which centers the hole gauge portion relative to the hole portion.

11. The gauge as set forth in claim 10 wherein the post includes a second post portion fixed to the first post portion, and the second post portion extends outwardly away from the first post portion to a distal end, wherein the hinge is disposed through the second post portion and the countersink gauge portion.

12. The gauge as set forth in claim 11 wherein:
the indicator includes a window and a needle fixed to the distal end of the second post portion;
the countersink gauge portion includes a plate having a top edge portion defining the window and a bottom edge portion having a pair of tapered edges opposing each other; and
the tapered edges engage the workpiece inside of the countersink portion of the aperture.

13. The gauge as set forth in claim 12 wherein the hinge is disposed proximal to the bottom edge portion of the countersink portion.

14. The gauge as set forth in claim 13 wherein:
the hinge is a pin extending along a first axis; and
the pin extends through the plate such that the plate is rotatable about the first axis.

15. The gauge as set forth in claim 1 wherein:
the indicator includes a stationary portion and a window;
the hole portion of the aperture is centered on a hole centerline, wherein the hole gauge portion aligns along the hole centerline;
the hole gauge portion includes a post and an alignment feature coupled to the post such that the alignment feature centers the hole gauge portion along the hole centerline when the post is disposed inside of the hole portion;
the countersink portion of the aperture is centered on a countersink centerline, wherein the countersink gauge portion aligns along the countersink centerline;
the indicator indicates whether a difference in angularity between the hole centerline and the countersink centerline is within the predetermined tolerance;
the stationary portion is fixed to the post such that the stationary portion extends beyond the post; and
the countersink gauge portion includes a plate having a top edge portion defining the window and a bottom edge portion having a pair of tapered edges opposing each other.

16. The gauge as set forth in claim 1 wherein:
the hole gauge portion includes a post and an alignment feature coupled to the post;
the countersink gauge portion includes a plate having a pair of tapered edges opposing each other; and
the indicator includes a stationary portion extending from the post and a window defined by the plate.

17. The gauge as set forth in claim 1 wherein the indicator includes a needle or a marking.

18. A method of determining a predetermined tolerance of an aperture of a workpiece, the method comprising:
inserting a hole gauge portion of a gauge into a hole portion of the aperture of the workpiece until a countersink gauge portion of the gauge is seated to a countersink portion of the aperture, wherein a hinge connects the hole gauge portion and the countersink gauge portion which allows the countersink gauge portion to move relative to the hole gauge portion once seated in the countersink portion; and
indicating, via an indicator coupled to the gauge, whether the predetermined tolerance is obtained between the countersink portion and the hole portion of the aperture.

19. The method as set forth in claim 18 wherein:
inserting the hole gauge portion into the hole portion of the aperture causes the hole gauge portion to align along a hole centerline of the hole portion of the aperture;
seating the countersink gauge portion into the countersink portion of the aperture causes the countersink gauge portion to align along a countersink centerline of the countersink portion of the aperture; and
indicating, via the indicator, whether a difference in angularity between the hole centerline and the countersink centerline is within the predetermined tolerance.

20. The method as set forth in claim 19 wherein:
indicating, via the indicator, further comprises indicating that the predetermined tolerance is obtained when a stationary portion of the indicator is visible inside of a window of the indicator; and
indicating, via the indicator, further comprises indicating that the predetermined tolerance is not obtained when the stationary portion is not visible inside of the window of the indicator.
